(19) United States
(12) Patent Application Publication
(10) Pub. No.: US 2025/0149228 A1
(43) Pub. Date: May 8, 2025

(54) MAGNETIC ELEMENT AND METHOD OF FORMING THE SAME

(71) Applicant: Delta Electronics (Shanghai) Co.,Ltd., Shanghai (CN)

(72) Inventors: Haijun YANG, Shanghai (CN); Lijun ZHOU, Shanghai (CN); Xiaoqiang YU, Shanghai (CN)

(21) Appl. No.: 18/925,069

(22) Filed: Oct. 24, 2024

(30) Foreign Application Priority Data
Nov. 2, 2023 (CN) 202311452173.2

(51) Int. Cl. H01F 27/24; H01F 27/28; H01F 41/02; H01F 41/04

(52) U.S. Cl. CPC H01F 27/24; H01F 27/28; H01F 41/0206; H01F 41/041

(57) ABSTRACT

The present disclosure discloses a magnetic element and a method of forming the same. The magnetic element includes a magnetic core including a magnetic column; a first electric conductor disposed on the magnetic column and including n conductive sheets, where n is an integer greater than or equal to 2, wherein the adjacent conductive sheets are fixed and formed in advance through an insulating material, each of the conductive sheets includes a main body part and a pin part extending outwardly from the main body part, and pin outlet directions of the pin parts of the adjacent conductive sheets form 360/n degrees; and a second electric conductor disposed on the magnetic column and interleaved with the first electric conductor along an axial direction of the magnetic column.

### CROSS-REFERENCE TO RELATED APPLICATIONS

This non-provisional application claims priority under 35 U.S.C. § 119(a) on Patent Application 202311452173.2 filed in P.R. China on Nov. 2, 2023, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### BACKGROUND OF THE DISCLOSURE

### 1. Field of the Disclosure

The present disclosure relates to the technical field of magnetic element, and particularly to a magnetic element and a method of forming the same.

### 2. Related Art

In application of high power supply, the unidirectional pin outlet way is often used, but heat and stress brought by heat are easily concentrated, causing that it is not easy to achieve high power efficiency, so magnetic elements with bidirectional, even multi-directional pins are gradually developed to achieve power dividing, so as to improve efficiency and heat dissipation of the circuit board. Currently, the relatively common method is to, for example, assemble and mount two copper sheets at a low-voltage high-current side symmetrically by 180°, using an inner plastic sleeve, while having pins at both sides of an opening of the core respectively, and then wind coils at a high-voltage low-current side onto the plastic sleeve.

How to further improve the power density of the power supply, especially, the power density of the magnetic element, improve the utilization rate of winding and simplify manufacturing is the problem urgently to be solved in the industry.

### SUMMARY OF THE DISCLOSURE

An object of the present disclosure is to provide a magnetic element capable of solving one or more deficiencies of the prior art.

In order to achieve the object, the present disclosure provides a magnetic element, including: a magnetic core including a magnetic column; a first electric conductor disposed on the magnetic column and including n conductive sheets, where n is an integer greater than or equal to 2, wherein the adjacent conductive sheets are fixed and formed in advance through an insulating material, each of the conductive sheets includes a main body part and a pin part extending outwardly from the main body part, and pin outlet directions of the pin parts of the adjacent conductive sheets form 360/n degrees; and a second electric conductor disposed on the magnetic column and interleaved with the first electric conductor along an axial direction of the magnetic column.

In order to achieve the object, the present disclosure provides a magnetic element, including: a magnetic core including a magnetic column; a first electric conductor disposed on the magnetic column and including n conductive sheets, where n is an integer greater than or equal to 2, the conductive sheets are one-nth turn of windings, each including two pins, and directions of the two pins form 360/n degrees, wherein the n conductive sheets are fixed and formed in advance through an insulating material; and a second electric conductor disposed on the magnetic column and interleaved with the first electric conductor along an axial direction of the magnetic column.

In order to achieve the object, the present disclosure provides a method of forming a magnetic element, including: providing a magnetic core including a magnetic column; providing a first electric conductor disposed on the magnetic column, the first electric conductor including n conductive sheets, where n is an integer greater than or equal to 2, wherein the adjacent conductive sheets are fixed and formed in advance through an insulating material, each of the conductive sheets includes a main body part and a pin part extending outwardly from the main body part, and pin outlet directions of the pin parts of the adjacent conductive sheets form 360/n degrees; providing a second electric conductor disposed on the magnetic column; and interleaving the first electric conductor with the second electric conductor along an axial direction of the magnetic column.

In order to achieve the object, the present disclosure provides a method of forming a magnetic element, including: providing a magnetic core including a magnetic column; providing a first electric conductor disposed on the magnetic column, the first electric conductor including n conductive sheets, where n is an integer greater than or equal to 2, the conductive sheets are one-nth turn of windings, each including two pins, and directions of the two pins form 360/n degrees, wherein the n conductive sheets are fixed and formed in advance through an insulating material; providing a second electric conductor disposed on the magnetic column; and interleaving the first electric conductor with the second electric conductor along an axial direction of the magnetic column.

### BRIEF DESCRIPTION OF THE DRAWINGS

To illustrate the technical solution implemented in this disclosure more clearly, hereinafter simple introduction is made to the accompanying drawings to be used in the embodiments.

FIG. 1 is a topological diagram of a circuit in the art.

FIGS. 2A and 2B are structural diagrams of a magnetic element in the prior art.

FIG. 3 is a structural diagram of a magnetic element in a first embodiment of the present disclosure.

FIGS. 4A and 4B are structural diagrams of a first electric conductor in the first embodiment.

FIG. 5A is a structural diagram of a first electric conductor in a second embodiment of the present disclosure.

FIG. 5B is a structural diagram of a magnetic core in the second embodiment of the present disclosure.

FIG. 6 is a structural diagram of a first electric conductor and a second electric conductor in the first embodiment.

FIG. 7 is a flow diagram of a method of forming a magnetic element in the first embodiment and the second embodiment of the present disclosure.

FIGS. 8A and 8B are structural diagrams of a first electric conductor in a third embodiment of the present disclosure.

FIG. 8C is a structural diagram of a first electric conductor in a fourth embodiment of the present disclosure.

FIG. 9 is a flow diagram of a method of forming a magnetic element in the third embodiment and the fourth embodiment of the present disclosure.

Additional aspects and advantages of the present disclosure will be in part set forth in the following description, and in part will be obvious from the description, or can be learned by practice of the present disclosure.

### DETAILED EMBODIMENTS OF THE DISCLOSURE

The example embodiments will now be described more fully with reference to the accompanying drawings. The example embodiments can, however, be implemented in various forms, and should not be construed as being limited to the embodiments set forth herein; rather, these embodiments are provided so that this disclosure will be thorough and complete, and will fully and completely convey the concept of the example embodiments to those skilled in the art.

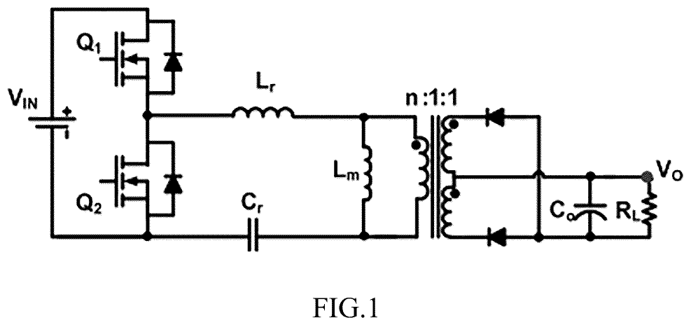

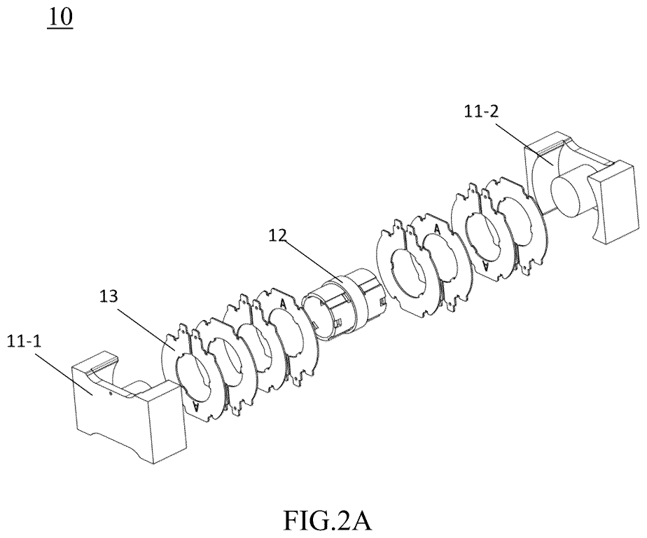

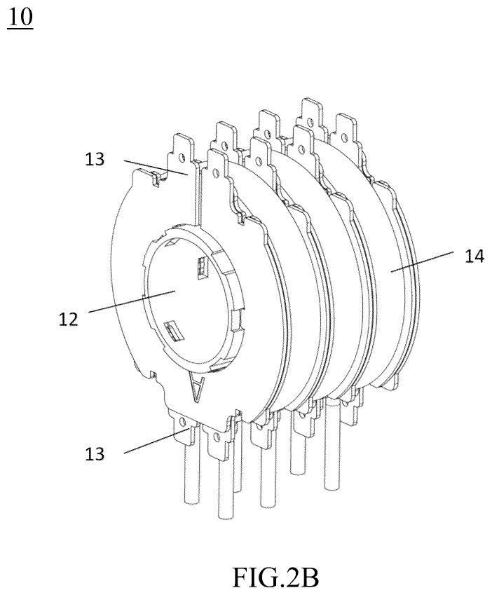

FIG. 1 shows a topology of a LLC circuit in the art. A primary side of the LLC circuit is a half-bridge inverter (or full-bridge or push-pull), a secondary side thereof is a full wave (or bridge) rectifier, and a resonant tank is connected to primary inverter and secondary rectifier, and includes a resonant capacitor, a resonant inductor and a transformer with a certain turn ratio and a magnetizing inductor. The common application is that the primary side extracts electricity from a high-voltage side (e.g., an output side of a power factor correction circuit), i.e., an input voltage Vin is relatively high, while a current is relatively small, and the secondary side outputs electricity to power the low-voltage equipment, i.e., an output voltage Vo is relatively low, and a current is relatively large. Therefore, as for the critical component transformer, the primary side often uses a triple insulated litz wire or a taping strand wire in other forms, and the secondary side often uses a copper sheet winding to carry a large current. In some embodiments, the secondary copper sheet often uses bidirectional to multi-directional output to optimize efficiency, heat and thermal stress of the magnetic element. The common structure of the magnetic element is shown in FIGS. 2A and 2B, the magnetic element 10 includes a pair of cores (i.e., cores 11-1 and 11-2), a sleeve 12, a plurality of paired copper sheets 13 fitted onto the sleeve 12, and a plurality of primary windings 14 wound at intervals of the plurality of paired copper sheets 13, and pin outlet directions of the paired copper sheets 13 are distributed at 180 degrees. Firstly, the manufacturing method of the magnetic element 10 is to assemble the plurality of paired copper sheets 13 onto the sleeve 12, then wind the plurality of primary windings 14 onto the sleeve 12, so it is difficult to manufacture, and consumes much time, and the presence of the sleeve also necessarily occupies a certain space of winding and affect heat dissipation of the entire magnetic element to a certain extent.

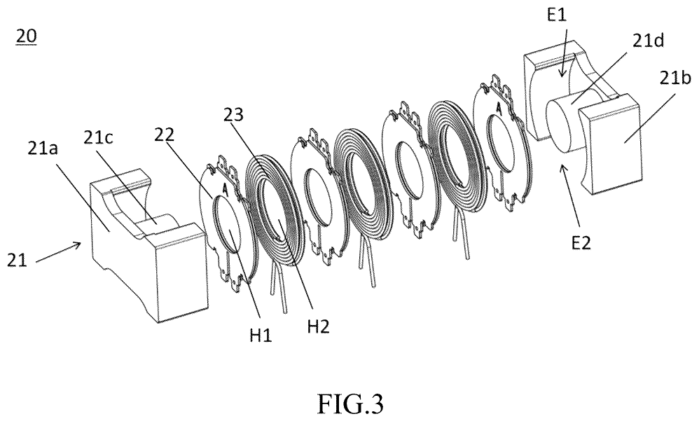

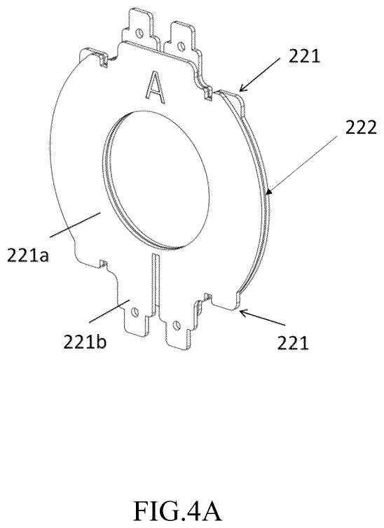

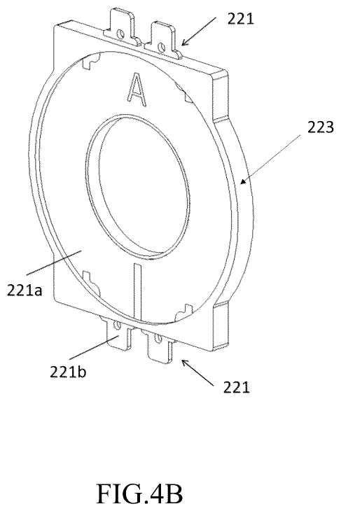

FIG. 3 is a structural diagram of a magnetic element 20 in a first embodiment of the present disclosure. As shown in FIG. 3, the magnetic element 20 includes a magnetic core 21, a first electric conductor 22 and a second electric conductor 23. The magnetic core 21 includes a magnetic column, and specifically, the magnetic core 21 includes a pair of magnetic cores 21a, 21b and magnetic columns 21c, 21d. The first electric conductor 22 is disposed on the magnetic column. Referring to FIGS. 4A and 4B, the first electric conductor 22 includes two conductive sheets 221, each of the conductive sheets 221 includes a main body part 221a and a pin part 221b extending outwardly from the main body part 221a, pin outlet directions of the pin parts 221b of the two conductive sheets are distributed at 180 degrees, and the two conductive sheets 221 are fixed and formed in advance through an insulating material. As shown in FIG. 4A, the two conductive sheets 221 are fixed and formed through an insulating tape 222, or as shown in FIG. 4B, the two conductive sheets 221 are fixed and formed through a colloid 223. As shown in FIG. 3, the second electric conductor 23 is disposed on the magnetic column, and interleaved with the first electric conductor 22 along an axial direction of the magnetic column. The pair of magnetic cores 21a, 21b includes two outlets E1 and E2, respectively, and when the first electric conductor 22 is disposed in the magnetic core 21, the pin parts 221b of the two conductive sheets 221 of the first electric conductor 22 are guided outwardly along the outlets E1 and E2 of the magnetic core 21, respectively.

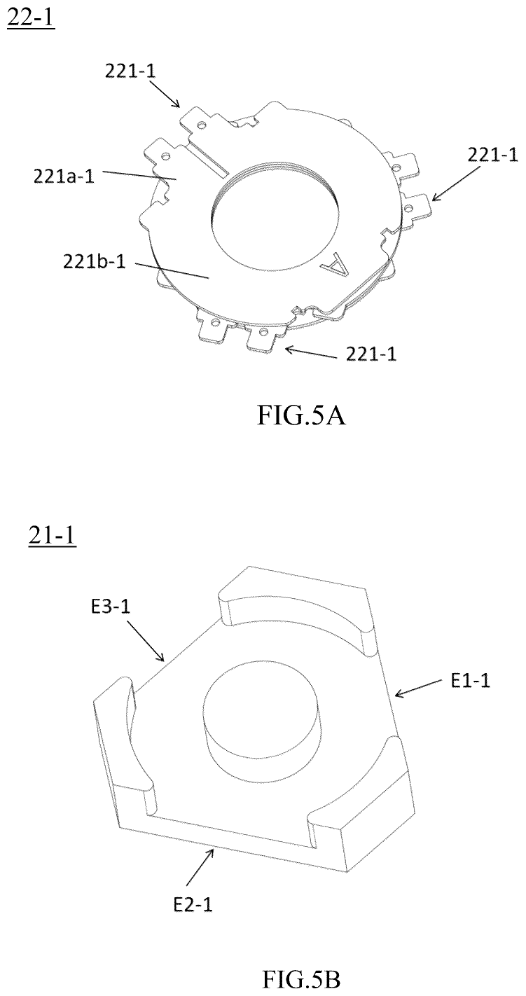

In other embodiments, the first electric conductor includes n conductive sheets, where n is an integer greater than or equal to 2, wherein the adjacent conductive sheets are fixed and formed in advance through an insulating material, each of the conductive sheets includes a main body part and a pin part extending outwardly from the main body part, pin outlet directions of the pin parts of the adjacent conductive sheets form 360/n degrees, and for example, the insulating material is an insulating tape or colloid. The magnetic core includes n outlets, and the pin parts of the n conductive sheets are guided outwardly along the outlets. Specifically, FIG. 5A is a structural diagram of a first electric conductor 22-1 in a second embodiment of the present disclosure, and FIG. 5B is a structural diagram of a magnetic core 21-1 in the second embodiment of the present disclosure. Referring to FIG. 5A, the first electric conductor 22-1 includes three conductive sheets 221-1, the adjacent conductive sheets 221-1 are fixed and formed in advance through an insulating material, each of the conductive sheets 221-1 includes a main body part 221a-1 and a pin part 221b-1 extending outwardly from the main body part 221a-1, and pin outlet directions of the pin parts 221b-1 of the adjacent conductive sheets 221-1 form 120 degrees. Correspondingly, as shown in FIG. 5B, the magnetic core 21-1 includes three outlets, which are E1-1, E2-1 and E3-1, respectively, and when the first electric conductor 22-1 is disposed in the magnetic core, the pin parts 221b-1 of the three conductive sheets 221-1 of the first electric conductor 22-1 are guided outwardly along the three outlets of the magnetic core, respectively.

Please continue to refer to FIG. 3, the first electric conductor 22 has a first center hole H1, the second electric conductor 23 has a second center hole H2, the first center hole H1 and the second center hole H2 are arranged correspondingly to each other, the magnetic columns 21c, 21d pass through the first center hole H1 and the second center hole H2, and the first electric conductor 22 and the second electric conductor 23 are directly disposed on the magnetic column.

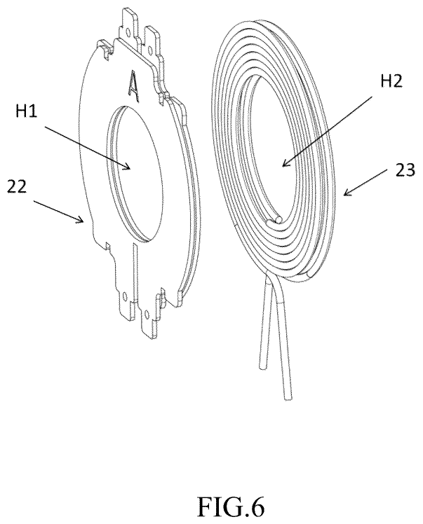

In the embodiment shown by FIGS. 3 and 6, the first electric conductor 22 is a metal sheet, and in other embodiments, the first electric conductor 22 is a PCB winding.

Combining FIGS. 3 and 6, the second electric conductor 23 is a wire-pie, the forming way of the wire-pie includes bonding forming from a three-layer insulated litz wire of a reversely wrapped tape or a litz wire of a reversely wrapped tape (which is referred to as a reversely wrapped tape wire, i.e., reversely wrapped outwardly of the adhesive surface of the tape), forming from a three-layer insulated self-adhesive wire, or preforming from a common three-layer insulated wire. The reversely wrapped tape wire uses a three-layer insulated litz wire or a common litz wire as a substrate, and is covered with an insulating tape with the back adhesive outwardly on the substrate, and when the reversely wrapped tape wire is used for making the wire-pie, since a surface layer has the adhesive, it may be produced using automation equipment, and easy for forming. In other embodiments, the second electric conductor 23 may be a PCB winding.

As shown in FIG. 3, the magnetic element 20 includes four first electric conductors 22 and three second electric conductors 23 arranged interleaving along an axial direction of the magnetic column, and when the magnetic element acts as a transformer, a secondary side of the magnetic element 20 uses the first electric conductors 22, and a primary side of the magnetic element 20 uses the second electric conductors 23. In other embodiments, the number and layout of the first electric conductors 22 and the second electric conductors 23 are not limited to the structure shown in FIG. 3, and the magnetic element 20 may include m first electric conductors 22 and (m-1) second electric conductors 23, where m is an integer greater than or equal to 2. And in some embodiments, the magnetic element 20 may include one first electric conductor 22 and one second electric conductor 23. The layout way may be primary-secondary, primary-secondary-primary, secondary-primary-secondary, secondary-primary-secondary-primary-secondary, or the like.

The first electric conductors of the magnetic element disclosed by the present disclosure have n conductive sheets with multi-directional pins, the adjacent conductive sheets are fixed in advance using an insulating tape with a double-sided-glue tape or a colloid forming way, and the n conductive sheets with multi-directional pins are distributed at 360/n degrees, thereby omitting the step of assembling the first electric conductor and the sleeve and the step of winding the primary side onto the sleeve, and reducing manufacturing time and manufacturing difficulty. After assembling and forming with the first electric conductor, the preformed second electric conductor is then directly combined with the core, such that the space occupied by the original sleeve may be fully utilized, and it may be at least possible, for example, to thicken a wire diameter of the primary side or increase a size of the first electric conductor, or decrease a volume and weight of the magnetic element, thereby effectively enhancing a power density of the magnetic element. Moreover, the first electric conductor and the second electric conductor are in direct contact with the core, thereby facilitating heat transfer of the winding.

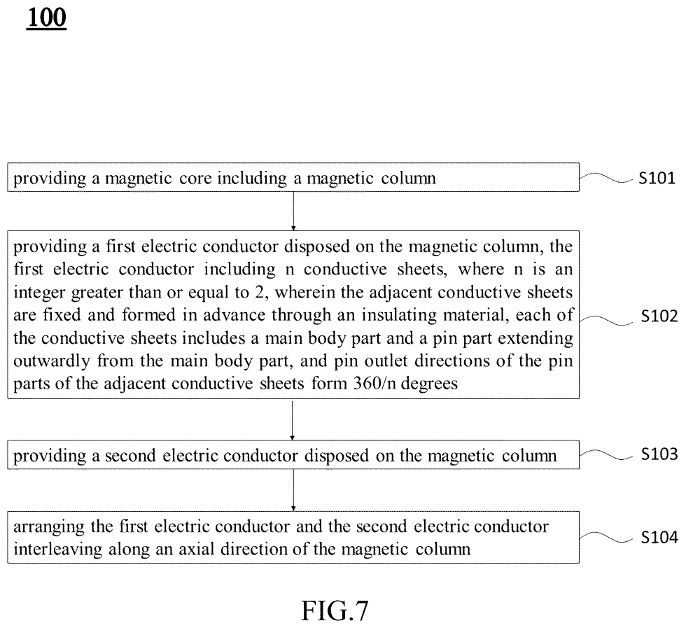

FIG. 7 shows a manufacturing method 100 of the magnetic element 20, and as shown in FIG. 7, the manufacturing method 100 includes steps of:
S101: providing a magnetic core including a magnetic column;
S102: providing a first electric conductor disposed on the magnetic column, the first electric conductor including n conductive sheets, where n is an integer greater than or equal to 2, wherein the adjacent conductive sheets are fixed and formed in advance through an insulating material, each of the conductive sheets includes a main body part and a pin part extending outwardly from the main body part, and pin outlet directions of the pin parts of the adjacent conductive sheets form 360/n degrees;
S103: providing a second electric conductor disposed on the magnetic column; and
S104: arranging the first electric conductor and the second electric conductor interleaving along an axial direction of the magnetic column.
   wherein a first center hole is formed in the first electric conductor, a second center hole is formed in a second electric conductor, the first center hole and the second center hole are arranged correspondingly to each other, the magnetic column passes through the first center hole and the second center hole, and the first electric conductor and the second electric conductor are directly disposed on the magnetic column. The magnetic core includes n outlets, and the pin parts of the n conductive sheets are guided outwardly along one of the n outlets, respectively.

In step S102, the insulating material is an insulating tape or colloid, and the first electric conductor is a metal sheet or PCB winding.

In step S103, the second electric conductor is a wire-pie, wherein the forming way of the wire-pie includes bonding forming from a reversely wrapped tape wire, forming from a three-layer insulated self-adhesive wire, or preforming from a common three-layer insulated wire. Alternatively, the second electric conductor is a PCB winding.

In step S104, the magnetic element includes m first electric conductors and (m-1) second electric conductors, where m is an integer greater than or equal to 2, and the m first electric conductors and the (m-1) second electric conductors are interleaving along an axial direction of the magnetic column.

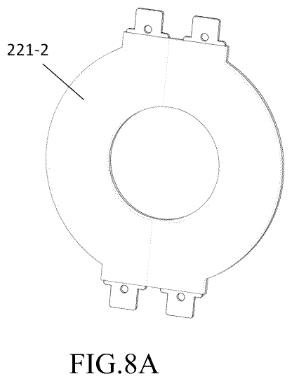

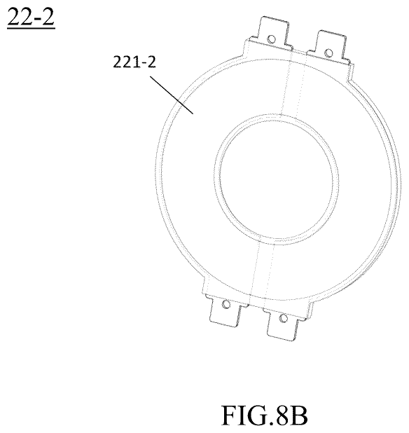

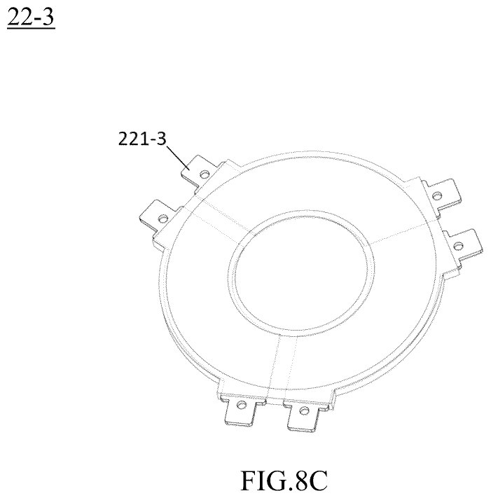

Referring to FIGS. 8A and 8B, the third embodiment of the present disclosure further provides a magnetic element, a structure of the magnetic element is substantially the same as the structure of the magnetic element 20, and the main difference is that the first electric conductor 22-2 includes two conductive sheets 221-2. The conductive sheets 221-2 are one-half turn of windings, each including two pins, directions of the two pins form 180 degrees, and the two conductive sheets 221-2 are fixed and formed in advance through an insulating material. As shown in FIG. 8A, the two conductive sheets 221-2 are fixed and formed by a tape, or as shown in FIG. 8B, the two conductive sheets 221-2 are fixed and formed by colloid. In other embodiments, the first electric conductor includes n conductive sheets, where n is an integer greater than or equal to 2. The conductive sheets are one-nth turn of windings, each including two pins, directions of the two pins form 360/n degrees, and the n conductive sheets are fixed and formed in advance through an insulating material.

FIG. 8C shows a structure of the first electric conductor in a fourth embodiment of the present disclosure. The first electric conductor 22-3 includes three conductive sheets 221-3, the conductive sheets 221-3 are one-third turn of windings, each including two pins, directions of the two pins form 120 degrees, and the three conductive sheets 221-3 are fixed and formed in advance through an insulating material.

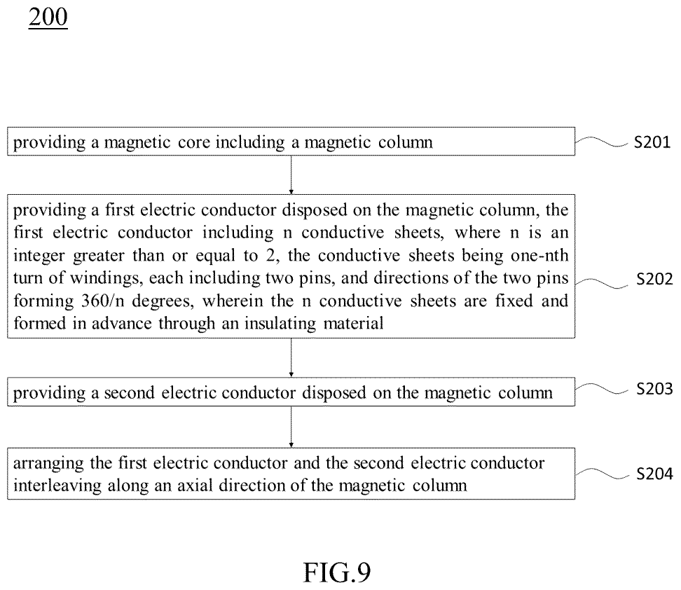

FIG. 9 shows a manufacturing method 200 of a magnetic element including the first electric conductor shown in FIGS. 8A-8C, and the manufacturing method 200 includes steps of:
S201: providing a magnetic core including a magnetic column;
S202: providing a first electric conductor disposed on the magnetic column, the first electric conductor including n conductive sheets, where n is an integer greater than or equal to 2, the conductive sheets being one-nth turn of windings, each including two pins, and directions of the two pins forming 360/n degrees, wherein the n conductive sheets are fixed and formed in advance through an insulating material;
S203: providing a second electric conductor disposed on the magnetic column; and
S204: arranging the first electric conductor and the second electric conductor interleaving along an axial direction of the magnetic column.

In conclusion, the embodiments of the present disclosure provide a sleeveless magnetic element with multi-directional pins and a method of forming the same, which may improve a power density of the power supply, especially, a power density of the magnetic element, more efficiently utilize a winding window area of the core under a certain volume, simplify manufacturing, and may at least bring the following four advantages: 1. on the premise of maintaining the volume unchanged, effectively improve power processing capability of the power supply; 2. simplify manufacturing difficulty and reduce the production cost; 3. no sleeve enables more fully heat exchange and heat transfer between the heating elements; 4. allow heat dispersion of the magnetic element, reduce the resistance and improve the power supply efficiency.

Although the embodiments of the present disclosure have been illustrated and described, it can be understood that those ordinary in the art may make various changes, modifications, alternations and variations to these embodiments without departing from the principle and spirit of the present disclosure, and the protection scope of the present disclosure is subjected to the scope defined by the appended claims.

What is claimed is:

1. A magnetic element, comprising:
a magnetic core comprising a magnetic column;
a first electric conductor disposed on the magnetic column and comprising n conductive sheets, where n is an integer greater than or equal to 2, wherein the adjacent conductive sheets are fixed and formed in advance through an insulating material, each of the conductive sheets comprises a main body part and a pin part extending outwardly from the main body part, and pin outlet directions of the pin parts of the adjacent conductive sheets form 360/n degrees; and
a second electric conductor disposed on the magnetic column and interleaved with the first electric conductor along an axial direction of the magnetic column.

2. The magnetic element according to claim 1, wherein the first electric conductor has a first center hole, the second electric conductor has a second center hole, the first center hole and the second center hole are arranged correspondingly to each other, and the magnetic column passes through the first center hole and the second center hole.

3. The magnetic element according to claim 1, wherein the first electric conductor and the second electric conductor are directly disposed on the magnetic column.

4. The magnetic element according to claim 1, wherein the magnetic core comprises n outlets, and the pin parts of the n conductive sheets are guided outwardly along the n outlets respectively.

5. The magnetic element according to claim 1, wherein the insulating material is an insulating tape or colloid.

6. The magnetic element according to claim 1, wherein the second electric conductor is a wire-pie, wherein the forming way of the wire-pie comprises bonding forming from a reversely wrapped tape wire, forming from a three-layer insulated self-adhesive wire, or preforming from a common three-layer insulated wire.

7. The magnetic element according to claim 1, wherein the second electric conductor is a PCB winding.

8. The magnetic element according to claim 1, wherein the first electric conductor is a metal sheet or a PCB winding.

9. The magnetic element according to claim 1, wherein the magnetic element comprises m first electric conductors and (m-1) second electric conductors, where m is an integer greater than or equal to 2.

10. A magnetic element, comprising:
a magnetic core comprising a magnetic column;
a first electric conductor disposed on the magnetic column and comprising n conductive sheets, where n is an integer greater than or equal to 2, the conductive sheets are one-nth turn of windings, each comprising two pins, and directions of the two pins form 360/n degrees, wherein the n conductive sheets are fixed and formed in advance through an insulating material; and
a second electric conductor disposed on the magnetic column and interleaved with the first electric conductor along an axial direction of the magnetic column.

11. A method of forming a magnetic element, comprising:
providing a magnetic core comprising a magnetic column;
providing a first electric conductor disposed on the magnetic column, the first electric conductor comprising n conductive sheets, where n is an integer greater than or equal to 2, wherein the adjacent conductive sheets are fixed and formed in advance through an insulating material, each of the conductive sheets comprises a main body part and a pin part extending outwardly from the main body part, and pin outlet directions of the pin parts of the adjacent conductive sheets form 360/n degrees;
providing a second electric conductor disposed on the magnetic column; and
interleaving the first electric conductor and the second electric conductor along an axial direction of the magnetic column.

12. The method of forming a magnetic element according to claim 11, wherein a first center hole is formed in the first electric conductor, and a second center hole is formed in the second electric conductor, wherein the first center hole and the second center hole are arranged correspondingly to each other, and the magnetic column passes through the first center hole and the second center hole.

13. The method of forming a magnetic element according to claim 11, wherein the first center hole and the second center hole are directly disposed on the magnetic column.

14. The method of forming a magnetic element according to claim 11, wherein the magnetic core comprises n outlets, and the pin parts of the n conductive sheets are guided outwardly along the n outlets respectively.

15. The method of forming a magnetic element according to claim 11, wherein the insulting material is an insulating tape or colloid.

16. The method of forming a magnetic element according to claim 11, wherein the second electric conductor is a wire-pie, wherein the forming way of the wire-pie comprises bonding forming from a reversely wrapped tape wire, forming from a three-layer insulated self-adhesive wire, or preforming from a common three-layer insulated wire.

17. The method of forming a magnetic element according to claim 11, wherein the second electric conductor is a PCB winding.

18. The method of forming a magnetic element according to claim 11, wherein the first electric conductor is a metal sheet or a PCB winding.

19. The method of forming a magnetic element according to claim 11, wherein the magnetic element comprises m first electric conductors and (m-1) second electric conductors, where m is an integer greater than or equal to 2.

20. A method of forming a magnetic element, comprising:
providing a magnetic core comprising a magnetic column;
providing a first electric conductor disposed on the magnetic column, the first electric conductor comprising n conductive sheets, where n is an integer greater than or equal to 2, the conductive sheets are one-nth turn of windings, each comprising two pins, and directions of the two pins form 360/n degrees, wherein the n conductive sheets are fixed and formed in advance through an insulating material;
providing a second electric conductor disposed on the magnetic column; and
interleaving the first electric conductor and the second electric conductor along an axial direction of the magnetic column.
